(19) United States
(12) Patent Application Publication
(10) Pub. No.: US 2017/0267253 A1
(43) Pub. Date: Sep. 21, 2017

(54) AVOIDING OR ALLEVIATING TRAVEL SICKNESS IN A VEHICLE

(71) Applicant: Ford Global Technologies, LLC, Dearborn, MI (US)

(72) Inventors: Eike Schmidt, Koeln/NRW (DE); Florian Golm, Herzogenrath/NRW (DE); Stefan Wolter, Wurselen/NRW (DE)

(73) Assignee: Ford Global Technologies, LLC, Dearborn, MI (US)

(21) Appl. No.: 15/463,421

(22) Filed: Mar. 20, 2017

(30) Foreign Application Priority Data
Mar. 21, 2016 (DE) 102016204635.7

(51) Int. Cl. B60W 50/00; B60W 40/107; B60W 50/08; B60W 40/08

(52) U.S. Cl. CPC B60W 50/0098; B60W 40/08; B60W 40/107; B60W 50/0097; B60W 50/082; B60W 2540/22; B60W 2040/0872

(57) ABSTRACT

The disclosure relates to a method and a device for avoiding or alleviating travel sickness in a vehicle, wherein the vehicle exhibits an automated driving mode in which the vehicle moves along at least partly in automated manner. A method according to the disclosure comprises the following steps: estimating at least one parameter that is characteristic of the probability of the occurrence of travel sickness in an occupant of the vehicle, establishing, on the basis of this parameter, at least one measure that is suitable for the alleviation or avoidance of travel sickness in the occupant of the vehicle, and communicating an item of information relating to this at least one measure to the driver.

### CROSS-REFERENCE TO RELATED APPLICATION

The subject patent application claims priority to and all the benefits of German Patent Application No. 102016204635.7 filed on Mar. 21, 2016, which is herein incorporated by reference in its entirety.

The present disclosure relates to a method and a device for avoiding or alleviating travel sickness in a vehicle.

Numerous occupants of vehicles suffer from nausea or travel sickness in the course of traveling. This is the case, in particular, when activities such as reading a book or watching videos are being carried out. Conservative estimates assume an occurrence of the symptoms of travel sickness in about 10% of the population.

Problems of travel sickness have hitherto occurred primarily in the other occupants of the vehicle (that is to say, not in the driver), since these people do not themselves have to steer the vehicle and are therefore in a position to carry out the stated activities. The stated activities are known to increase the probability of the occurrence of travel sickness.

With the progressive introduction of the technology of automated driving, however, the frequency of the occurrence of travel sickness may increase, since the driver of a vehicle becomes a passenger himself/herself for a certain period of time. In the case of a high degree of automation, the driver is consequently in a position to carry out a variety of activities that lead to travel sickness. In this connection, he/she may even move his/her seat position into the rear region of the vehicle or may, by a rotation of the seat, change his/her direction of view by up to 180°, as a result of which the probability of the occurrence of travel sickness is increased in each instance.

From DE 10 2014 221 337 A1 a method, among other things, is known, in which, on the basis of data collected with respect to a motion of a vehicle, it is determined whether a limit that is associated with travel sickness has been exceeded. In this case, on the basis of the collected data the adjustment is undertaken of a component in the vehicle, for instance a video display, a mirror, a seat, a lamp or an air-conditioning system.

From EP 2 228 089 A1 a method and a device, among other things, for alleviating travel sickness in occupants of a vehicle—such as, for example, an aircraft, a car or a ship—are known, wherein a visual representation of the current environmental conditions and of the environmental conditions to be expected in future is displayed to the respective occupant.

From GB 2 515 616 A a method, among other things, for avoiding travel sickness in occupants of a vehicle is known, in which the acceleration of the vehicle is displayed to the occupants with differing color displays corresponding to the risk of the occurrence of travel sickness.

Disclosed herein is a method and a device for avoiding or alleviating travel sickness in a vehicle, which, particularly in the case of partly or completely automated driving, can avoid or at least reduce or alleviate the occurrence of travel sickness.

Disclosed is a method for avoiding or alleviating travel sickness in a vehicle, said vehicle exhibiting an automated driving mode in which the vehicle moves along at least partly in automated manner, the method comprising:

estimating at least one parameter that is characteristic of the probability of the occurrence of travel sickness in an occupant of the vehicle,

establishing, on the basis of this parameter, at least one measure that is suitable for the alleviation or avoidance of travel sickness in the occupant of the vehicle, and

communicating an item of information relating to this at least one measure to the driver.

The present disclosure involves, in particular, the concept of avoiding an occurrence of travel sickness by reason of the option for automated driving which is given in a vehicle. In this connection, the disclosure proceeds from the consideration that, in principle, the option of automated driving gives a driver or occupants of the vehicle the possibility for the implementation of a large number of possible activities that are suitable to trigger travel sickness.

According to an example, the at least one suitable measure includes the termination of the automated driving mode or the avoidance of a change-over to the automated driving mode.

According to an example, the at least one suitable measure further includes at least one of the following measures: changing or terminating an activity currently being carried out by the driver, changing the seat position of the driver, changing the setting of at least one window covering of the vehicle.

If the driver has already been driving in the automated driving mode, he/she can accordingly be prompted, in particular, to change over to the manual driving mode, to change the type of activity presently being carried out, or to terminate this activity (for instance, with the prompt “Stop reading”, “Stop watching videos”, etc.), to change his/her seat position, or to change the visual configuration (for instance, with the prompt “Open window blinds”, “Close your eyes for a certain time”, etc.). If the driver has already been driving manually—or, to be more exact, by himself/herself—it can be suggested to him/her to retain the manual driving mode and/or to avoid certain activities, seat positions or visual configurations that are known to increase the probability of the occurrence of travel sickness.

According to an example, the step of estimating the at least one parameter that is characteristic of the probability of the occurrence of travel sickness is carried out on the basis of items of information or data relating to the driver.

The disclosure consequently further involves the principle of estimating, on the basis of a large number of data items, a parameter that is characteristic of the probability of the occurrence of travel sickness. If this parameter exceeds a threshold value—which, for example, was ascertained on the basis of practical tests or field trials—the driver is warned appropriately, and possible countermeasures are suggested. The estimation of said parameter may be carried out on the basis of map material or data relating to the course of the route (curviness, speed restrictions to be expected, changes of altitude etc.), vehicle data (acceleration sequences, excitation of the vehicle by the roadway surface etc.) and data relating to preceding driver activities and driver states (for example, type of driver activity, last duration of this activity, last duration of automated driving, last seat position, health data, previous history etc.).

According to an example, the items of information or data relating to the driver consequently comprise the type of an activity currently being carried out by the driver, the duration of a previously undertaken implementation of the activity currently being carried out by the driver, the duration of a previously undertaken journey of the vehicle in the automated driving mode, and/or health data pertaining to the driver.

According to an example, the step of estimating the at least one parameter that is characteristic of the probability of the occurrence of travel sickness is carried out on the basis of data relating to the current environment of the vehicle or to the environment of the vehicle to be expected in future.

According to an example, the data relating to the current environment of the vehicle or to the environment of the vehicle to be expected in future relate to the curviness of the route being driven, existing speed limits and/or changes of altitude of the route being driven.

According to an example, the step of estimating the at least one parameter that is characteristic of the probability of the occurrence of travel sickness is carried out on the basis of data relating to the operating condition of the vehicle.

According to an example, the data relating to the operating condition of the vehicle relate to acceleration data pertaining to the vehicle and/or the excitation of the vehicle by the roadway surface.

The disclosure further relates to a device for avoiding or alleviating travel sickness in a vehicle, said device having been configured to implement a method having the features described above. With respect to advantages as well as preferred configurations of the device, reference is made to the above remarks in connection with the method according to the disclosure.

Further configurations of the disclosure can be gathered from the description and also from the dependent claims.

The disclosure will be elucidated in more detail in the following on the basis of an exemplary embodiment with reference to the appended illustration.

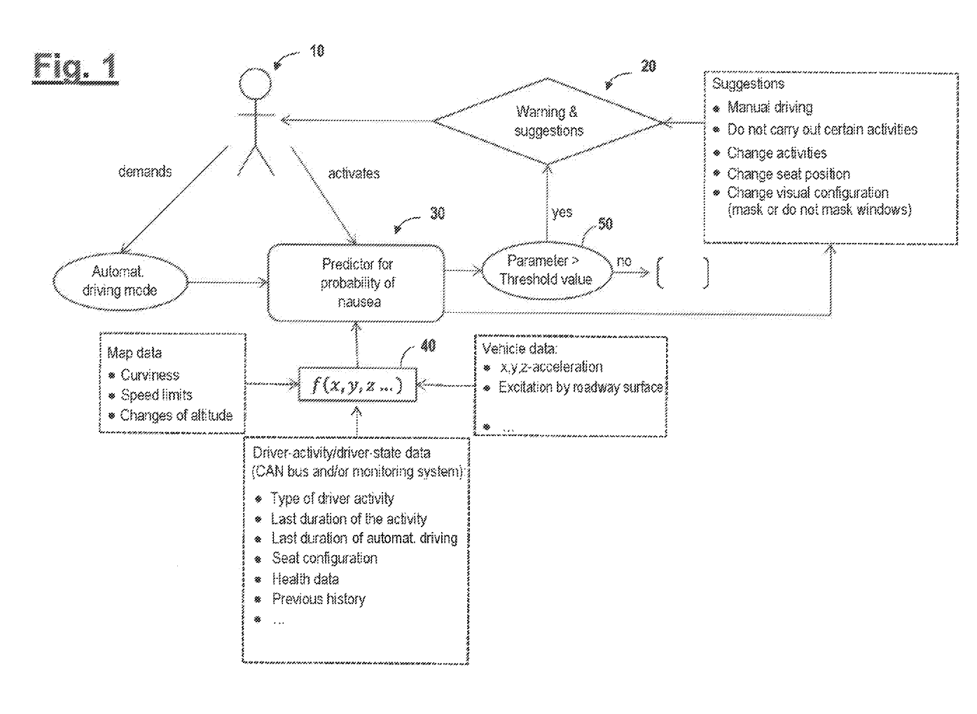

The single FIG. 1 shows a diagram for elucidating the possible sequence of a method according to the disclosure.

According to FIG. 1, it is assumed that a driver or occupant, denoted by “10”, of the vehicle sets an automated driving mode in his/her vehicle for (at least partial) automated driving and activates a prediction unit for predicting a probability of travel sickness (that is to say, the probability of the occurrence of travel sickness), which is denoted by “30”, or that this prediction unit 30 has already been activated in advance as standard.

This prediction of the probability of travel sickness is undertaken according to FIG. 1 on the basis of a function 40, with reference to which the probability of nausea can be ascertained on the basis of a large number of data items. In the exemplary embodiment shown in FIG. 1, these data include (but are not limited to) map data (for example curviness, speed restrictions, changes of altitude), driver-activity data and driver-state data (for example, type of driver activity, last duration of the activity, last duration of automated driving, seat configuration, health data, previous history etc.) as well as vehicle data (acceleration data, excitation of the vehicle by roadway surface etc.).

On the basis of the aforementioned data, according to FIG. 1 an appropriate parameter is ascertained on the basis of the estimate of the probability of nausea. Then, in a step 50, the query is undertaken as to whether this parameter exceeds a predetermined threshold value (which, for instance, was ascertained on the basis of practical tests or field trials). If this is the case, according to step 20 a warning (for example, a visual or acoustic warning), which may be associated with appropriately suitable suggestions, is given to the driver. These suggestions may involve, in merely exemplary manner, the transition to the manual driving mode or, where appropriate, the retention thereof, refraining from certain activities, changing certain activities, the change of the seat position or the change of a visual configuration (for example, the opening or closing of window blinds).

1-11. (canceled)

12. A method, comprising:
operating a vehicle in an automated driving mode in which the vehicle moves at least partly in automated manner;
estimating at least one parameter that is characteristic of a probability of an occurrence of travel sickness in an occupant of the vehicle;
establishing, on the basis of the at least one parameter, at least one measure to alleviate travel sickness in the occupant of the vehicle; and
communicating an item of information relating to the at least one measure to the occupant.

13. The method of claim 12, wherein establishing the at least one measure is undertaken upon determining that the parameter exceeds a predetermined threshold value.

14. The method of claim 12, wherein the at least one measure includes one of terminating the automated driving mode and avoiding a change-over to the automated driving mode.

15. The method of one of claims 12, wherein the at least one measure further includes at least one of the following: changing or terminating an activity currently being carried out by the occupant, changing a seat position of the occupant, and changing the setting of at least one window covering of the vehicle.

16. The method of claim 12, wherein estimating the at least one parameter that is characteristic of the probability of the occurrence of travel sickness is carried out based on data relating to the occupant.

17. The method of claim 16, wherein the items of information or data relating to the driver comprise one or more of a type of an activity currently being carried out by the occupant, a duration of a previously undertaken instance of the activity currently being carried out by the occupant, a duration of a previously undertaken journey of the vehicle in the automated driving mode, and health data pertaining to the occupant.

18. The method of claim 12, wherein estimating the at least one parameter that is characteristic of the probability of the occurrence of travel sickness is carried out based on one or more of data relating to a current environment of the vehicle and data relating to an expected future environment of the vehicle.

19. The method of claim 18, wherein the data relating to the current environment of the vehicle and to the expected future environment of the vehicle relate to one or more of a curviness of a route being driven, existing speed limits and changes of altitude of the route being driven.

20. The method of claim 12, wherein estimating the at least one parameter that is characteristic of the probability of the occurrence of travel sickness is carried out based on data relating to an operating condition of the vehicle.

21. The method of claim 20, wherein the data relating to the operating condition of the vehicle relate to one or more of vehicle acceleration data and an excitation of the vehicle by the roadway surface.

22. A device for avoiding or alleviating travel sickness in a vehicle, comprising a computer programmed to:
operate a vehicle in an automated driving mode in which the vehicle moves at least partly in automated manner;
estimate at least one parameter that is characteristic of a probability of an occurrence of travel sickness in an occupant of the vehicle;
establish, on the basis of the at least one parameter, at least one measure to alleviate travel sickness in the occupant of the vehicle; and
communicate an item of information relating to the at least one measure to the occupant.

23. The device of claim 22, the computer further programmed to determine that the parameter exceeds a predetermined threshold value, wherein establishing the at least one measure is undertaken upon determining that the parameter exceeds the predetermined threshold value.

24. The device of claim 22, wherein the at least one measure includes one of terminating the automated driving mode and avoiding a change-over to the automated driving mode.

25. The device of one of claims 22, wherein the at least one measure further includes at least one of the following: changing or terminating an activity currently being carried out by the occupant, changing a seat position of the occupant, and changing the setting of at least one window covering of the vehicle.

26. The device of claim 22, the computer further programmed to estimate the at least one parameter that is characteristic of the probability of the occurrence of travel sickness based on data relating to the occupant.

27. The device of claim 26, wherein the items of information or data relating to the driver comprise one or more of a type of an activity currently being carried out by the occupant, a duration of a previously undertaken instance of the activity currently being carried out by the occupant, a duration of a previously undertaken journey of the vehicle in the automated driving mode, and health data pertaining to the occupant.

28. The device of claim 22, the computer further programmed to estimate the at least one parameter that is characteristic of the probability of the occurrence of travel sickness based on one or more of data relating to a current environment of the vehicle and data relating to an expected future environment of the vehicle.

29. The device of claim 28, wherein the data relating to the current environment of the vehicle and to the expected future environment of the vehicle relate to one or more of a curviness of a route being driven, existing speed limits and changes of altitude of the route being driven.

30. The device of claim 22, the computer further programmed to estimate the at least one parameter that is characteristic of the probability of the occurrence of travel sickness based on data relating to an operating condition of the vehicle.

31. The device of claim 30, wherein the data relating to the operating condition of the vehicle relate to one or more of vehicle acceleration data and an excitation of the vehicle by the roadway surface.
